(19) United States
(12) Patent Application Publication
(10) Pub. No.: US 2011/0220109 A1
(43) Pub. Date: Sep. 15, 2011

(54) MOUTH MASK

(75) Inventors: Chun-Liang CHIU, Taipei City (TW); Mao Sheng CHI, Taipei City (TW)

(73) Assignees: Chun-Liang CHIU, Taipei City (TW); Mao Sheng CHI, Taipei City (TW)

(21) Appl. No.: 12/722,618

(22) Filed: Mar. 12, 2010

(51) Int. Cl. A62B 23/02

(52) U.S. Cl. 128/206.19

(57) ABSTRACT

A mouth mask includes a mask body and fixing elements connected to the mask body. The mask body includes a waterproof nonwoven layer, a skin-contact nonwoven layer, and a filtering nonwoven layer provided between the waterproof nonwoven layer and the skin-contact nonwoven layer to correspond to mouth and nose of a user. The dimension of the waterproof nonwoven layer is the same as that of the skin-contact nonwoven layer. The dimension of the filtering nonwoven layer is smaller than that of the waterproof nonwoven layer and the skin-contact nonwoven layer. With the above structure, a mouth mask is provided, which is more comfortable when worn and has a less production cost.

### BACKGROUND OF THE INVENTION

1. Field of the Invention

The present invention relates to a mouth mask, and in particular to a mouth mask which is more comfortable when worn and has a less production cost.

2. Description of Related Art

Mouth mask can be worn on the face of a user to cover his/her mouth and nose. The mouth mask can filter external air, so that the user can breathe in a filtered and fresher air, thereby preventing the respiratory tract of the user from being infected by unclean air. Thus, the mouth masks have become popular commodities.

The conventional mouth mask usually has a mask body of a multi-layered structure. The outermost layer of the mask body is a waterproof nonwoven layer for preventing the penetration of liquid. The middle layer is a filtering nonwoven layer made of a high-density material with a better filtering effect. The innermost layer is a skin-contact nonwoven layer made of a hydrophilic material for absorbing the moisture expired by the user. With the filtration of the filtering nonwoven layer, pernicious gases can be filtered off and may not be inhaled by the user.

Although the above-mentioned mouth mask can filter off the pernicious gases, the area of the filtering nonwoven layer is so large that the user may feel uncomfortable and muggy when wearing such a mouth mask due to the poor air permeability of the mask body.

In order to overcome the above-mentioned problems, the present inventor proposes a novel and reasonable structure based on his delicate researches and expert experiences.

### SUMMARY OF THE INVENTION

An objective of the present invention is to provide a mouth mask which is more comfortable when worn and has a less production cost.

To achieve the above objectives, the present invention provides a mouth mask, which includes a mask body and fixing elements connected to the mask body. The mask body has a waterproof nonwoven layer, a skin-contact nonwoven layer, and a filtering nonwoven layer provided between the waterproof nonwoven layer and the skin-contact nonwoven layer to match with mouth and nose of a user. The dimension of the waterproof nonwoven layer is the same as that of the skin-contact nonwoven layer. The dimension of the filtering nonwoven layer is smaller than that of the waterproof nonwoven layer and the skin-contact nonwoven layer.

The present invention has advantageous features as follows. Since the dimension of the filtering nonwoven layer is smaller than that of the waterproof nonwoven layer and the skin-contact nonwoven layer, the portion on the face of the user other than the mouth and nose is only covered by the waterproof nonwoven layer and the skin-contact nonwoven layer of the mask body, so that the mask body has a better breathability. Further, the resistance between the mask body and the face can be reduced. Thus, the user feels the mouth mask more breathable and comfortable even wearing for a long period of time. On the other hand, since the filtering nonwoven layer is more expensive, the production cost of the mouth mask can be reduced by decreasing the dimension of the filtering nonwoven layer.

In order to further understand the characteristics and technical contents of the present invention, a description relating thereto will be made with reference to the accompanying drawings. However, the drawings are illustrative only but not used to limit the present invention.

### BRIEF DESCRIPTION OF THE DRAWINGS

FIG. 1 is an assembled perspective view showing a first embodiment of the present invention;

FIG. 2 is an exploded perspective view showing the first embodiment of the present invention;

FIG. 3 is a cross-sectional view showing the mask body of the first embodiment according to the present invention;

FIG. 4 is a side view showing the first embodiment of the present invention;

FIG. 5 is a partially enlarged view of FIG. 4;

FIG. 6 is an exploded perspective view showing a second embodiment of the present invention;

FIG. 7 is an assembled perspective view showing the second embodiment of the present invention;

FIG. 7A is an assembled perspective view showing that an adhesive strip is located on an upper end according to the second embodiment of the present invention;

FIG. 7B is an assembled perspective view showing that an adhesive strip is located on a lower end according to the second embodiment of the present invention;

FIG. 8 is an assembled perspective view showing a third embodiment of the present invention;

FIG. 9 is an exploded perspective view showing the mask body according to the third embodiment of the present invention;

FIG. 10 is an assembled perspective view showing a fourth embodiment of the present invention;

FIG. 11 is an exploded perspective view showing the mask body of the fourth embodiment according to the present invention;

FIG. 12 is an assembled perspective view showing a fifth embodiment of the present invention;

FIG. 13 is an assembled perspective view showing a sixth embodiment of the present invention;

FIG. 14 is an assembled perspective view showing a seventh embodiment of the present invention;

FIG. 15 is an assembled perspective view showing an eighth embodiment of the present invention; and

FIG. 16 is an assembled perspective view showing a ninth embodiment of the present invention.

### DETAILED DESCRIPTION OF THE PREFERRED EMBODIMENTS

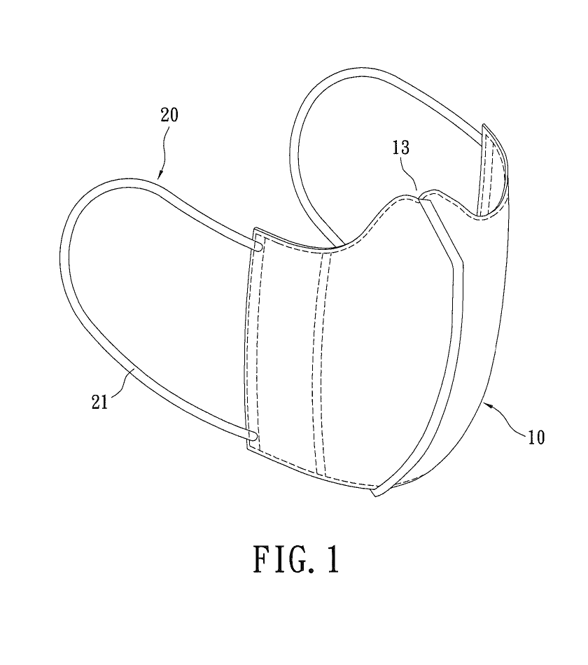

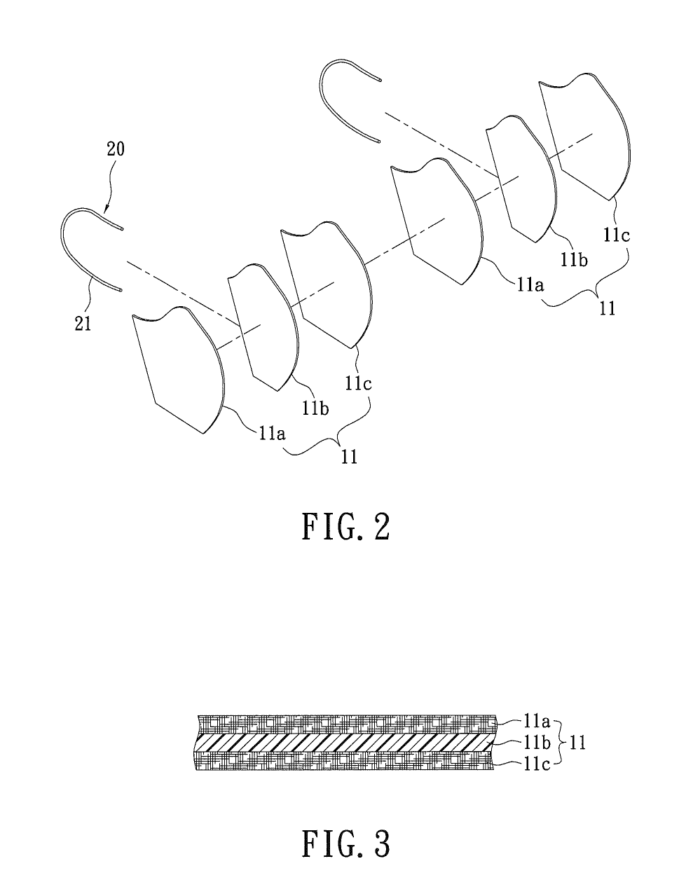

Please refer to FIGS. 1 and 2, which show the mouth mask of the first embodiment according to the present invention. The mouth mask includes a mask body 10 and fixing elements 20. In the present embodiment, the mask body 10 is formed by connecting two identical thermoplastic nonwoven sheets 11. The thermoplastic nonwoven sheet 11 is of a multi-layered structure. In the present invention, the thermoplastic nonwoven sheet 11 has a three-layered structure, but it is not limited thereto.

Each of the thermoplastic nonwoven sheets 11 includes a waterproof nonwoven layer 11a, a skin-contact nonwoven layer 11c, and a filtering nonwoven layer 11b. The waterproof nonwoven layer 11a is a thermoplastic polypropylene (PP) nonwoven. The waterproof nonwoven layer 11a is located in the outermost layer of the thermoplastic nonwoven sheet 11 for preventing the penetration of liquid.

The skin-contact nonwoven layer 11c is a thermoplastic composite-fiber nonwoven, such as a thermoplastic nonwoven made of ethylene-and-styrene co-polymer (ES). The skin-contact nonwoven layer 11c is located in the innermost layer (i.e., the layer for directly contacting the face of a user) of the thermoplastic nonwoven sheet 11. The skin-contact nonwoven layer 11c is hydrophilic and capable of absorbing the moisture expired by the user.

The filtering nonwoven layer 11b is a thermoplastic mesh-like nonwoven, such as a thermoplastic melt-blown nonwoven. The filtering nonwoven layer 11b is located between the waterproof nonwoven layer 11a and the skin-contacting nonwoven layer 11c (FIG. 3). The filtering nonwoven layer 11b has a larger density, thereby a better filtering effect is provided.

The dimension of the waterproof nonwoven layer 11a is the same as that of the skin-contact nonwoven layer 11c. The dimension of the filtering nonwoven layer 11b is smaller that that of the waterproof nonwoven layer 11a and the skin-contact nonwoven layer 11c. Further, the location of the filtering nonwoven layer 11b matches with the mouth and nose of the user.

The rear end of each of the thermoplastic nonwoven sheet 11 is connected to the fixing element 20. In the present embodiment, the fixing elements 20 are two elastic bands 21. Both ends of one elastic band 21 are fixedly connected to the upper and lower ends of the left-side thermoplastic nonwoven sheet 11 by a hot-melting process. Similarly, the other elastic band 21 is fixedly connected to the upper and lower ends of the right-side thermoplastic nonwoven sheet 11 by a hot-melting process. In this way, an ear-hanging mouth mask can be formed.

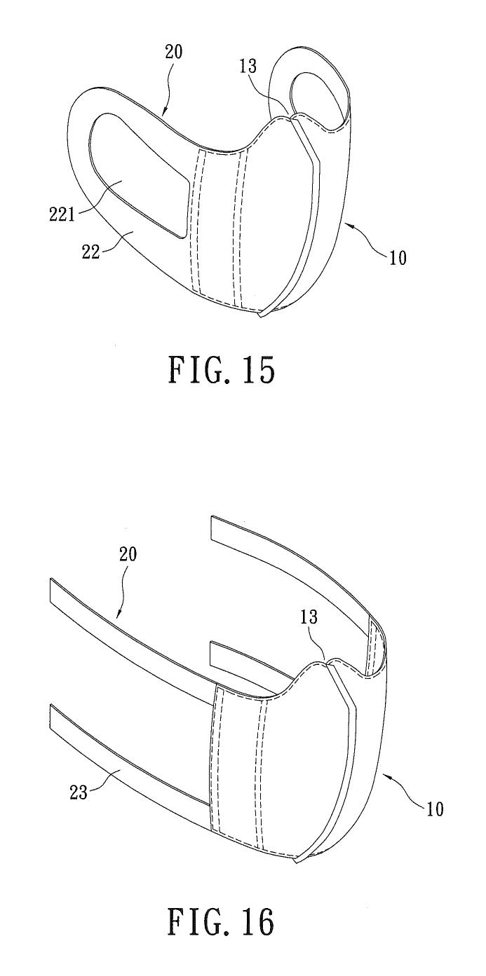

Alternatively, the fixing element 20 may be configured as an ear-hanging portion 22 (as shown in FIG. 15) in which a hanging hole 221 is provided, or tying strings 23 as shown in FIG. 16. The ear-hanging portions 22 or the tying strings 23 can be made of thermoplastic nonwoven or other materials.

When the mouth mask of the present invention is worn by the user, the mask body 10 tightly abuts the face of the user with the two elastic bands 21 hanging on the ears of the user respectively. Since the filtering nonwoven layer 11b suitably covers the mouth and nose of the user, the dimension of the filtering nonwoven layer 11b can be reduced to be different from that of the water nonwoven layer 11a and the skin-contact nonwoven layer 11c. Thus, the portion on the face of the user other than the mouth and nose can be only covered by the waterproof nonwoven layer 11a and the skin-contact nonwoven layer 11c. Thus, the mask body 10 has a better breathability, and the resistance between mouth body 10 and the face can be reduced. Therefore, the user will feel more comfortable and breathable even wearing for a long period of time. On the other hand, since the filtering nonwoven layer is more expensive, the production cost of the mouth mask can be reduced by decreasing the dimension of the filtering nonwoven layer.

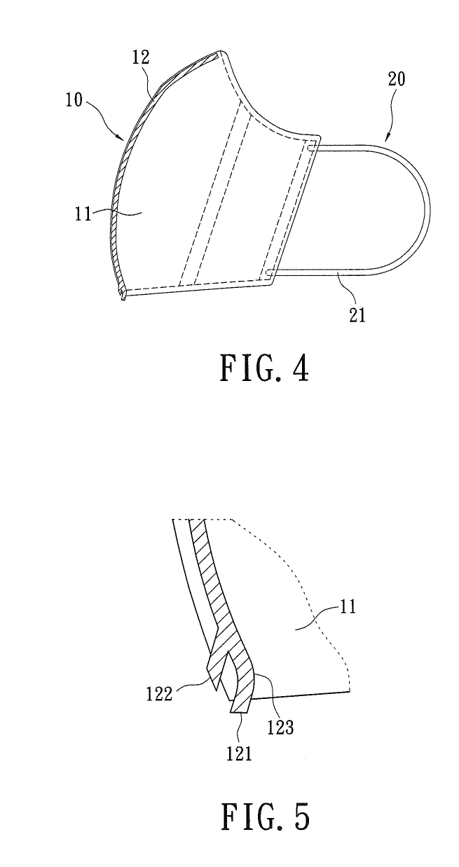

Please refer to FIG. 4. More specifically, the mask body 10 of the present embodiment is formed by adhering two adjacent sides of the two thermoplastic nonwoven sheets 11. The adhered portion forms an adhesive strip 12. The above-mentioned adhesion of the two thermoplastic nonwoven sheets 11 is achieved by a supersonic wave or high-frequency wave welding process. The adhesive strip 12 is formed with a bent end 121 at its one end close to the lower edge of the mask body 10 (as shown in FIG. 5). The bent end 121 extends to the lower edge of the mask body 10. The bent end 121 may slightly protrude from the mask body 10 or not protrude from the mask body 10. The connecting portion between the bent end 121 and the adhesive strip 12 forms a curved side 123. A secondary adhesive strip 122 is further provided adjacent to the bent end 121 and connected with the adhesive strip 12. The secondary adhesive strip 122 may slightly protrude from the mask body 10 or not protrude from the mask body 10. Further, please refer to FIG. 1. The mask body 10 is formed with a V-shaped opening 13 on the upper edge of the adhered portion of the two thermoplastic nonwoven sheets 11.

When the mouth mask is worn on the face of the user, the mask body 10 is pulled by the two connecting elements 20, so that the V-shaped opening 13 can be enlarged to make the mask body 10 more fit the face of the user. After being used for a period of time, the pulling forces exerted on the lower edge of the adhered portion of the two thermoplastic nonwoven sheets 11 will be distributed by the curved side 123 of the bent end 121. Thus, the two thermoplastic nonwoven sheets 11 will not be separated from each other. If the tearing force is so large that the lower edge of the adhered portion of the two thermoplastic nonwoven sheets 11 are separated from each other, the secondary adhesive strips 122 can prevent the two thermoplastic nonwoven sheets 11 from being split continuously, thereby maintaining the usability of the mask body 10.

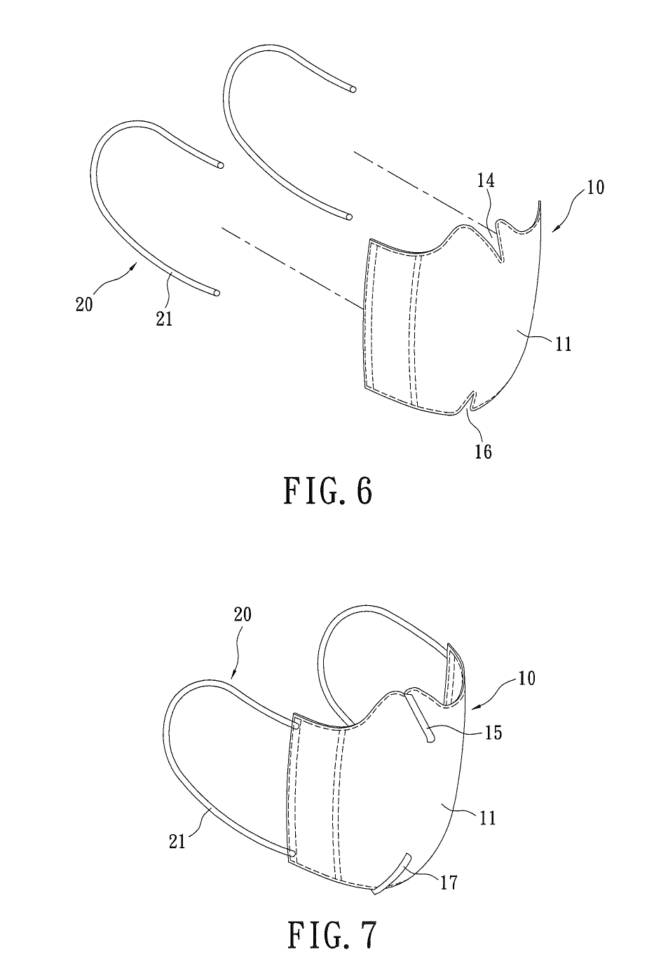

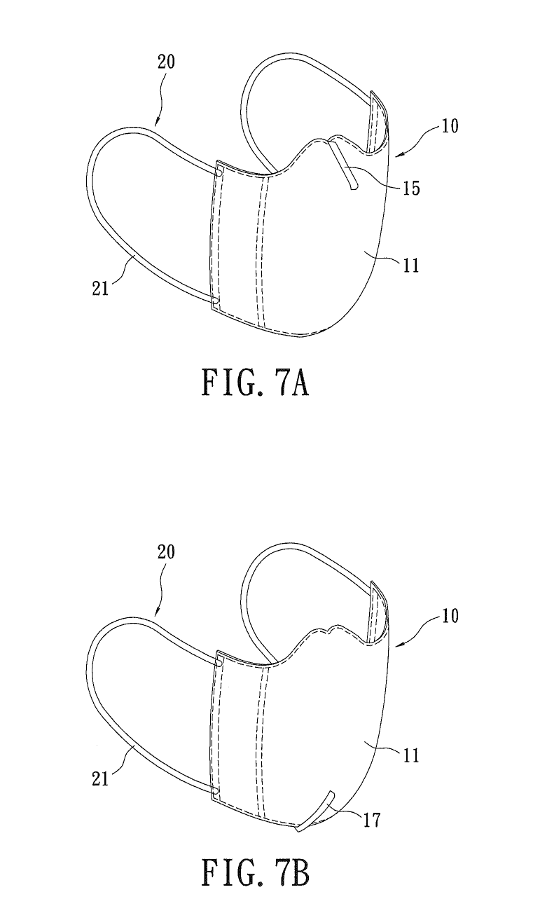

Please refer to FIGS. 6 and 7, which show the second embodiment of the present invention. In the present embodiment, the mask body 10 is formed into an integral unit. The mask body 10 is a thermoplastic nonwoven sheet 11 in which the waterproof nonwoven layer 11a, the skin-contact nonwoven layer 11c, and the filtering nonwoven layer 11b are provided. Also, the dimension of the filtering nonwoven layer 11b is smaller than that of the waterproof nonwoven layer 11a and the skin-contact nonwoven layer 11c.

The upper end and the lower end of the middle portion of the thermoplastic nonwoven sheet 11 are formed with a connecting notch 14, 16 respectively. Then, the two adhesive strips 15, 17 are used to connect to the connecting notches 14, 16, so that the middle portion of the mask body 10 is formed with the two separated adhesive strips 15, 17. The above-mentioned bent end, the secondary adhesive strip, the curved side or the like (not shown) can be similarly provided on the lower adhesive strip 17 adjacent to the lower edge of the mask body 10. The shape and function of the bent end, the secondary adhesive strip, or the curved side are substantially as those in the previous embodiment, and thus the description thereof is omitted herein for clarity. The advantage of this embodiment in the mask body 10 is integrally formed without a welded middle portion, which enhances the breathability. Further, the mask body 10 without welding portions also makes the user to feel more comfortable and smooth when wearing it on his/her face.

Alternatively, please refer to FIG. 7A. The thermoplastic nonwoven sheet 11 can be fowled with only one connecting notch (not shown) at an upper end of the middle portion, and the adhesive strip 15 is connected to the connecting notch. Alternatively, please refer to FIG. 7B. The thermoplastic nonwoven sheet 11 can be formed with only one connecting notch (not shown) at a lower end of the middle portion, and the adhesive strip 17 is connected to the connecting notch. In other words, there may be only one adhesive strip 17 located at the upper end or lower end of the mask body 10.

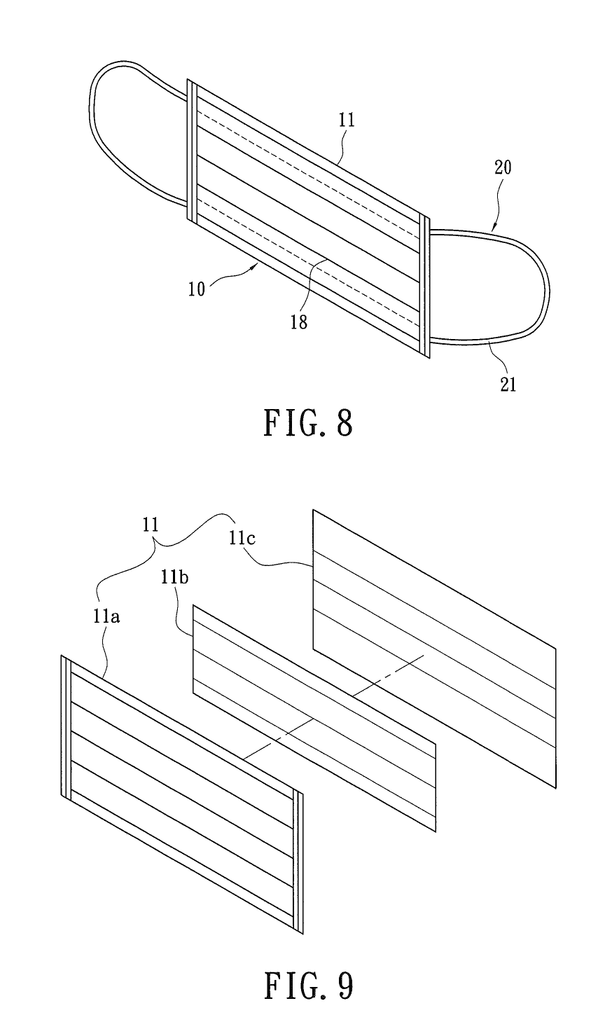

Please refer to FIGS. 8 and 9, which show the third embodiment of the mouth mask of the present invention. The difference between the third embodiment and the first embodiment lies in that: the present embodiment provides a planar mask body 10. Similarly, the mask body 10 is made of a thermoplastic nonwoven sheet 11 having a waterproof nonwoven layer 11a, a skin-contact nonwoven layer 11c, and a filtering nonwoven layer 11b. The thermoplastic nonwoven sheet 11 is provided with a plurality of creases 18. The filtering nonwoven layer 11b also covers the mouth and nose of the user. However, the dimension of the filtering nonwoven layer 11b in the short-side direction is smaller than that of the waterproof nonwoven layer 11a and the skin-contact nonwoven layer 11c.

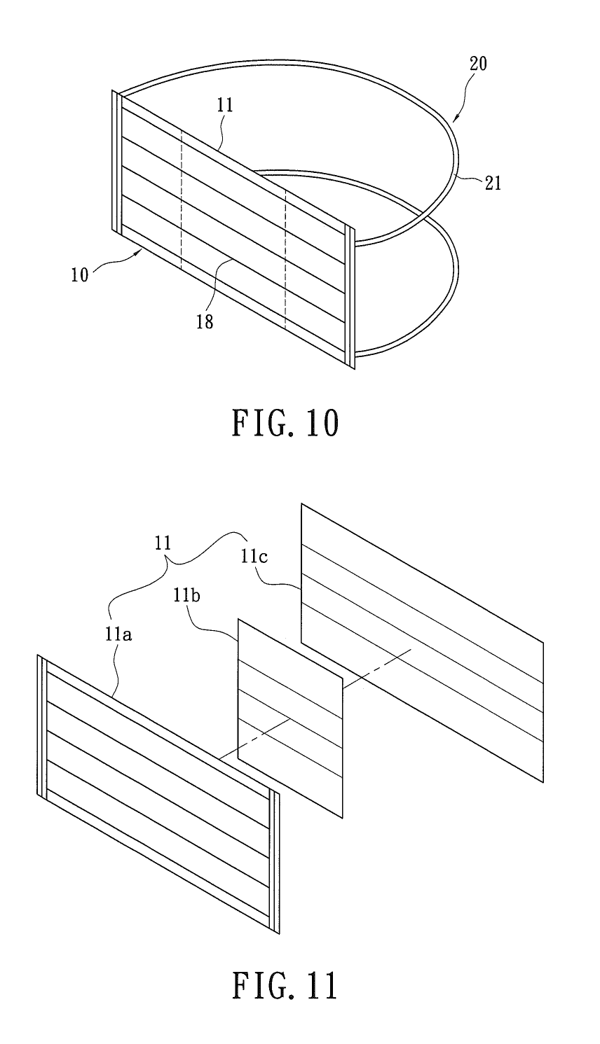

Please refer to FIGS. 10 and 11, which show the fourth embodiment of the mouth mask of the present invention. The difference between the fourth embodiment and the third embodiment lies in that: the rear end of the mask body 10 is connected with two elastic bands 21 parallel to each other, thereby forming a head-hanging mouth mask. Further, the filtering nonwoven layer 11b in the mask body 10 not only covers the mouth and nose of the user, but also the dimension of the filtering nonwoven layer 11b in the long-side direction is smaller than that of the waterproof nonwoven layer 11a and the skin-contact nonwoven layer 11c.

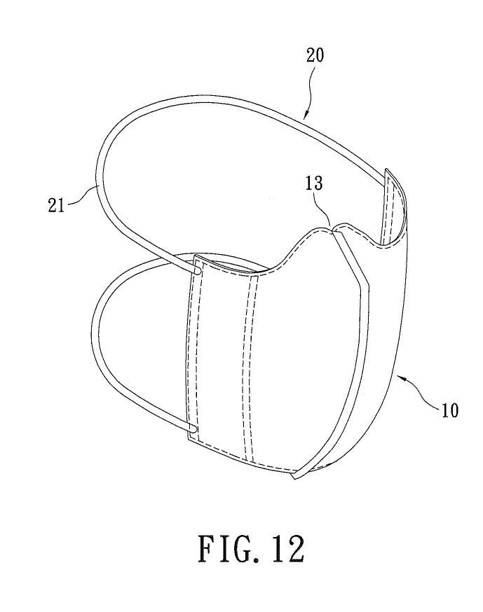

Please refer to FIG. 12, which shows the fifth embodiment of the mouth mask of the present invention. The difference between the fifth embodiment and the first embodiment lies in that: the two elastic bands 21 are connected in parallel to the rear end of the mask body 10, thereby forming a head-hanging mouth mask.

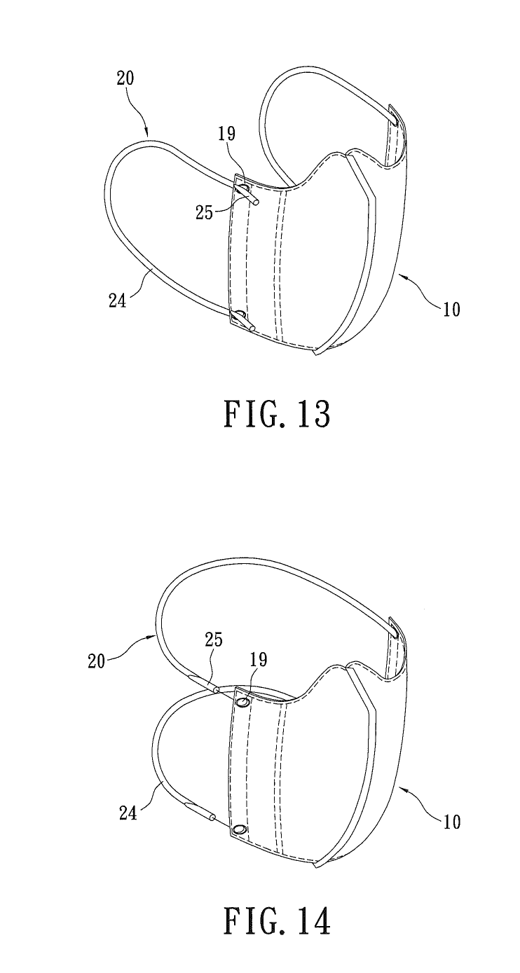

Please refer to FIG. 13, which shows the sixth embodiment of the mouth mask of the present invention, in which the left and right sides of the mask body 10 are respectively formed with two sets of connecting holes 19 opposite to each other in the vertical direction. There are two fixing elements 20, and each has a band 24 (such as an elastic band) made of an elastic material. Both ends of the band 24 are provided with a connecting piece 25 respectively. The connecting piece 25 of each fixing element 20 is detachably connected to the connecting hole 19 of the mask body 10, thereby forming a detachable mouth mask that the mask body 10 can be detached from the fixing elements 20.

In the present embodiment, with the connecting holes 19 and the connecting pieces 25 provided between the mask body 10 and the two fixing elements 20, the mask body 10 can be freely connected to or detached from the two fixing elements 20. Therefore, if the filtering effect of the mask body 10 is reduced after being used for a period of time, the user can only replace the old mask body 10 with a new one, and keep using the original fixing elements 20. As a result, the user needs not to adjust the length of the fixing elements 20 each time when replacing the mask body 10, thereby facilitating the wearing of the mouth mask, conforming to the requirements for environmental protection, and reducing the cost of the user.

Please refer to FIG. 14, which shows the seventh embodiment of the mouth mask of the present invention. The difference between the seventh embodiment and the sixth embodiment lies in that: the connecting pieces 25 on both ends of one fixing element 20 are connected to the connecting holes 19 located on both sides of the upper portion of the mask body 10, and the other fixing element 20 is connected to the connecting holes 19 located on both sides of the lower portion of the mask body 10, thereby forming a head-hanging mouth mask.

Please refer to FIG. 15, which show the eighth embodiment of the mouth mask of the present invention. The fixing element 20 can be an ear-hanging portion 22 in which a hanging hole 221 is provided. The ear-hanging portion 22 is integrally formed with the thermoplastic nonwoven sheet 11. Alternatively, the ear-hanging portion 22 can be made of a different material from the thermoplastic nonwoven sheet 11 and connected therewith.

Please refer to FIG. 16, which shows the ninth embodiment of the mouth mask of the present invention. As for a head-hanging mouth mask, the tying strings 23 connected to the mask body 10 are used to replace the fixing elements 20 in the previous embodiments. In use, two tying strings 23 are tied together to fix on the head of the user.

According to the present invention, the filtering nonwoven layer 11b suitably covers the mouth and nose of the user. Further, the dimension of the filtering nonwoven layer 11b is smaller than that of the waterproof nonwoven layer 11a and the skin-contact nonwoven layer 11c. Thus, the portion of the face of the user other than the mouth and nose is merely covered by the waterproof nonwoven layer 11a and the skin-contact nonwoven layer 11c, so that the mask body 10 has a better breathability. Also, the resistance between the mask body 10 and the face is reduced. Therefore, the user feels more comfortable and breathable even wearing the mouth mask for a long period of time. On the other hand, since the filtering nonwoven layer is more expensive, the production cost of the mouth mask can be reduced by decreasing the dimension of the filtering nonwoven layer 11b.

The above-mentioned descriptions represent merely the preferred embodiments of the present invention, without any intention to limit the scope of the present invention thereto. Various equivalent changes, alternations or modifications based on the claims of present invention are all consequently viewed as being embraced by the scope of the present invention.

What is claimed is:

1. A mouth mask, comprising:
a mask body having
a waterproof nonwoven layer;
a skin-contact nonwoven layer; and
a filtering nonwoven layer provided between the waterproof nonwoven layer, wherein, the skin-contact nonwoven layer matches mouth and nose of a user, the dimension of the waterproof nonwoven layer is the same as that of the skin-contact nonwoven layer, the dimension of the filtering nonwoven layer is smaller than that of the waterproof nonwoven layer and the skin-contact nonwoven layer; and
a pair of fixing elements connected to the mask body.

2. The mouth mask according to claim 1, wherein the mask body is formed by connecting two thermoplastic nonwoven sheets, each of the thermoplastic nonwoven sheets comprises the waterproof nonwoven layer, the skin-contact nonwoven layer, and the filtering nonwoven layer, two opposite sides of the two thermoplastic nonwoven sheets are adhered to each other, and the adhered portion forms an adhesive strip, one end of the adhesive strip adjacent to the lower edge of the mask body is formed with a bent end extending to the lower edge of the mask body, the mouth mask has a secondary adhesive strip adjacent to the bent end and connected to the adhesive strip, the upper edge of the adhered portion of the two thermoplastic nonwoven sheets forms a V-shape opening.

3. The mouth mask according to claim 1, wherein the mask body is a thermoplastic nonwoven sheet, the thermoplastic nonwoven sheet includes the waterproof nonwoven layer, the skin-contact nonwoven layer, and the filtering nonwoven layer.

4. The mouth mask according to claim 1, wherein the mask body is a thermoplastic nonwoven sheet, the thermoplastic nonwoven sheet includes the waterproof nonwoven layer, the skin-contact nonwoven layer, and the filtering nonwoven layer, a central portion of the mask body is adhered to form an adhesive strip, the adhesive strip is located at an upper end or a lower end of the mask body.

5. The mouth mask according to claim 1, wherein the mask body is a thermoplastic nonwoven sheet, the thermoplastic nonwoven sheet includes the waterproof nonwoven layer, the skin-contact nonwoven layer, and the filtering nonwoven layer, a central portion of the mask body is adhered to form two separated adhesive strips, one of the adhesive strips is located at an upper end of the mask body, and the other adhesive strip is located at a lower end of the mask body.

6. The mouth mask according to claim 1, wherein the filtering nonwoven layer is a thermoplastic mesh-like nonwoven.

7. The mouth mask according to claim 1, wherein the fixing elements are fixed to the mask body, the fixing elements are elastic bands or tying strings.

8. The mouth mask according to claim 1, wherein the mask body is provided with connecting holes, both ends of the fixing element are provided with connecting pieces, the connecting piece is detachably connected to the connecting hole.

9. The mouth mask according to claim 1, wherein the fixing element is an ear-hanging portion having a hanging hole.
